(19) United States
(12) Patent Application Publication
(10) Pub. No.: US 2024/0334198 A1
(43) Pub. Date: Oct. 3, 2024

(54) MANAGEMENT OF THE INSTALLATION OF AN ADDITIONAL WIRELESS COVERAGE EXTENSION DEVICE IN A LOCAL COMMUNICATION NETWORK COMPRISING A HOME GATEWAY AND AT LEAST ONE FIRST WIRELESS COVERAGE EXTENSION DEVICE

(71) Applicant: ORANGE, Issy-les-Moulineaux (FR)

(72) Inventors: Louis Carbonnel, CHÂTILLON CEDEX (FR); Yoann Vincent, CHÂTILLON CEDEX (FR)

(21) Appl. No.: 18/573,955

(22) PCT Filed: Jun. 14, 2022
(86) PCT No.: PCT/FR2022/051144

§ 371 Date: Dec. 22, 2023

(30) Foreign Application Priority Data
Jun. 29, 2021 (FR) 2107010

(51) Int. Cl. H04W 16/26; H04W 64/00; H04W 88/16

(52) U.S. Cl. CPC H04W 16/26; H04W 64/006; H04W 88/16

(57) ABSTRACT

A method, implemented by a mobile terminal capable of moving around in a local communication network including a home gateway and at least one first wireless coverage extension device. The home gateway and the first extension device form access points to the local network. The method includes determining an indication of the position of the mobile terminal with respect to the access points to the local network, the indication being capable of assuming a value chosen from a group of values including indications of positions that are too far away, too near, and optimal; rendering a suitable position for installing an additional wireless coverage extension device, corresponding to a current position of the mobile terminal when at least one of the indications of position assumes an indication of position value that is optimal and none of the indications of position assumes an indication of position value that is too near.

### TECHNICAL FIELD

The field of the invention is that of local communication networks operating, in whole or in part, using a wireless communication technology, for example the Wi-Fi wireless communication technology. More specifically, the invention relates to identifying an area in a home environment that is appropriate for installing a device intended to communicate using a wireless technology with another device in the home environment, for example a home gateway.

### PRIOR ART

To extend the Wi-Fi coverage of a home local network, it is known to install an extension home device, also known as a Wi-Fi extender, in a user's home environment, for example their home. Such a Wi-Fi extender provides a relay between the connected devices placed in the user's home environment and the home gateway acting as an access point to the IP (Internet Protocol) network.

Such a Wi-Fi extender is used in particular when certain locations in the home are not covered by the Wi-Fi local network of the home gateway, for example because the home gateway is too far away or because obstacles have been placed in the home environment (walls that are too thick, devices that interfere with the Wi-Fi signal). When a user acquires a Wi-Fi extender to extend the Wi-Fi coverage of their home gateway, a common problem is that they do not know where to place this Wi-Fi extender. Often, as the user is not familiar with the telecommunications field, they tend to place the Wi-Fi extender in the area not covered by the Wi-Fi network of the home gateway. However, such a location does not solve the Wi-Fi connection and service issues they encounter in these areas, since the Wi-Fi extender does not have access to the home gateway. A correct positioning of the Wi-Fi extender in the home environment is necessary to ensure a good Wi-Fi service quality for the user.

Current positioning assistance mechanisms are extremely basic. For example, an information LED may be available on the Wi-Fi extender device itself to indicate whether the Wi-Fi extender is correctly placed with respect to the home gateway. However, such an information LED only tells the user whether or not the Wi-Fi extender can connect to the home gateway. The LED does not tell them whether the Wi-Fi extender is optimally placed with respect to the home gateway. For example, information LEDs may be available on the Wi-Fi extender device itself to indicate whether the Wi-Fi extender is correctly placed with respect to the home gateway, for example a certain number of LEDs lit indicates a certain Wi-Fi signal quality. However, such LEDs do not tell the user whether the Wi-Fi extender is optimally placed with respect to the home gateway. For example, the Wi-Fi extender may be placed in an area where it can connect to the home gateway, but the Wi-Fi extender may be placed in an area that is considered too near the home gateway because the corresponding Wi-Fi coverage extension is not maximum, and another location for the Wi-Fi extender further away from the home gateway might be more relevant.

In addition, the LED information is only provided to the user once the Wi-Fi extender has been plugged in and started up. If the Wi-Fi extender has been placed too far away from the home gateway, the user must switch off and unplug the device and redo the installation in another location. Thus, it is not easy for a user to know the optimal location for a Wi-Fi extender in their home environment.

In an attempt to solve this problem, the Applicant has proposed a method for identifying an installation area for a device in a user's home environment, which is the subject of French patent application FR 3 088 782.

However, while this method solves the problem of positioning a first Wi-Fi extender in a home environment, it does not provide sufficient assistance to a user who wants to install several Wi-Fi extenders in a local communication network.

There is therefore a need for a technique that does not have these various disadvantages of the prior art. In particular, there is a need for such a technique that provides a practical and effective assistance to users who want to install several Wi-Fi extenders in the same local communication network, in order to improve the wireless coverage area of the latter.

### SUMMARY OF THE INVENTION

The invention responds to this need by proposing a method, implemented in a local communication network comprising a home gateway and at least one first wireless coverage extension device, for managing the installation of an additional wireless coverage extension device. Such a method for managing installation is implemented by a mobile terminal capable of moving around within the local communication network. The home gateway and said at least one first wireless coverage extension device form access points to the local network.

According to one embodiment of the invention, this method implements the steps of:
determining an indication of the position of the mobile terminal with respect to said access points to the local network,
   it being possible for the indication of position to assume a value chosen from a group of values comprising an indication of position that is too far away, an indication of position that is too near, and an indication of position that is optimal;
rendering a suitable position for installing the additional wireless coverage extension device, the suitable position corresponding to a current position of the mobile terminal when at least one of the indications of position assumes an indication of position value that is optimal and none of the indications of position assumes an indication of position value that is too near.

Thus, the invention is based on a completely new and inventive approach to assisting in the installation of wireless coverage extension devices in a home environment already comprising at least one such extension device.

Indeed, one embodiment of the invention is based on a dedicated application, installed on a user's mobile terminal, such as a smartphone.

When the user moves around in their home environment with their mobile terminal in their hand, the application assesses in real time the suitability of the location they are in for connecting the additional wireless coverage extension device, by determining an indication of position that is too near, optimal or too far away with respect to each of the access points of the local communication network.

In addition, as soon as the user is at an optimal distance from at least one of the access points to the network, and they are not too near any access point, the application tells the user that they are in a suitable position for installing their new wireless coverage extension device. This rendering can be done by displaying a message on the screen of the mobile terminal, by rendering an audio message or by transmitting a dedicated sound signal.

It is thus quite easy for the user to find a suitable position for installing a new wireless coverage extension device, whatever their home environment, and whatever the number of wireless coverage extension devices already present in the local communication network.

According to one embodiment, as long as the suitable installation position has not been rendered, such a method implements a rendering of the indications of position assuming an indication of position value that is too far away and/or an indication of position value that is too near.

Thus, depending on a name given by the user to each access point to the network (for example during a preliminary phase for installing the new extension device), the application can tell the user, through a message displayed on the screen of the mobile terminal, or through an audio message, that they are too near or too far away from either of the access points. For example, a message such as “you are too far away from the home gateway” and/or a message such as “you are too near the office extender” displays on the screen of the smartphone. The user can thus easily use these indications to move around in their home environment, moving nearer the gateway and/or further away from the desktop extender, until the application tells them that they are now in a suitable installation position.

According to one embodiment, determining an indication of the position of the mobile terminal with respect to one of the access points comprises at least one measurement of an instantaneous level of radio signal exchanged between the mobile terminal and the access point.

Indeed, the mobile terminal communicates using a wireless communication technology with each of the access points of the local communication network. According to a first variant, each access point assesses the level of radio signal transmitted by the mobile terminal: the lower this level, the greater the distance separating the mobile terminal from the access point. It is thus possible to deduce an indication of the position of the mobile terminal that is too near, too far away or optimal with respect to the access point. According to a second variant, the mobile terminal assesses the level of radio signal it receives from each of the access points to the network to deduce an indication of position that it is too near, too far away or optimal. In the first variant, the home gateway can centralise the information received from the various access points and transmit it to the mobile terminal.

According to one embodiment, since the mobile terminal communicates with the access points using a Wi-Fi wireless communication technology, the measurement of an instantaneous level of radio signal comprises a measurement, by the access point, of the received signal strength indication (RSSI) of the Wi-Fi signal transmitted by the mobile terminal.

The first variant mentioned above is thus considered. An RSSI measurement, which is a good indicator of the distance from the mobile terminal to the access point, is advantageously used.

However, the RSSI is, by nature, an item of information that is subject to constant variation, because it is influenced, for example, by the way the user holds their smartphone, or by the user's position with respect to their smartphone and to the other access points, or even by the Wi-Fi access point being masked by an obstacle (for example, the body of a user crossing the path between the mobile terminal and the access point).

As a result, according to one embodiment, determining an indication of the position of the mobile terminal with respect to one of the access points also comprises a calculation of an average value of measurements, by the access point, of the received signal strength indication of the Wi-Fi signal transmitted by the mobile terminal, over a time window of a defined duration.

Thus, instead of using the instantaneous RSSI value to determine the indication of position value of the mobile terminal with respect to the access point, the average of the latest RSSI values over a given time window is used: for example, for an RSSI measured every half-second, an average over four samples is calculated, in order to take into account the average RSSI value over a time window of two seconds. This advantageously avoids harmful oscillations of the indications of position values, which could disturb the user's understanding when they are close to a boundary between a positioning area that is too near and an optimal positioning area, for example. Indeed, given the environmental factors influencing the RSSI value, without this average value calculation, the positioning assistance application could change the indications of position values with respect to the various access points, from too near to optimal for example, and vice versa, for example every two or three seconds, even if the user and their mobile terminal were not moving. This could lead to confusing indications for the user, and would hinder the correct positioning of the new wireless coverage extension device.

Indeed, according to one embodiment, a change in the indication of position value occurs when the radio signal level measured crosses a defined radio signal level threshold. Several thresholds can thus be determined, corresponding to a boundary between a positioning area that is too near and an optimal positioning area on the one hand, and a boundary between an optimal positioning area and a positioning area that is too far away on the other hand.

However, according to an advantageous embodiment, a hysteresis mechanism is implemented which, coupled with the averaging of RSSI values, prevents oscillation between positioning areas when the user is near their boundaries. According to this hysteresis mechanism, the indication of position changes from an indication of position value that is optimal to an indication of position value that is too far away, respectively too near, when the measured radio signal level falls below a low threshold of an optimal radio signal level, respectively rises above a high threshold of an optimal radio signal level; the indication of position changes from an indication of position value that is too far away, respectively too near, to an indication of position value that is optimal when the measured radio signal level rises above a threshold of a radio signal level that is too weak, respectively falls below a threshold of a radio signal level that is too strong; furthermore, the low threshold of an optimal radio signal level is lower than the threshold of a radio signal level that is too weak and the high threshold of an optimal radio signal level is higher than the threshold of a radio signal level that is too strong.

Thus, this hysteresis mechanism is based on the use of different thresholds to move from a positioning area that is too far away from the access point to an optimal positioning area, and vice versa;

similarly, it is based on the use of different thresholds to move from a positioning area that is too near the access point to an optimal positioning area, and vice versa. This reduces the occurrence of oscillations impacting the indications of position values with respect to the various access points, which are still likely to occur, even when using an RSSI mean value calculation. Indeed, the number of RSSI samples used to calculate the average must remain limited, to avoid introducing too much inertia into the assessment of the mobile terminal's position.

According to a particular characteristic, a difference between the threshold of a radio signal level that is too weak and the low threshold of an optimal radio signal level is greater than a difference between the high threshold of an optimal radio signal level and the threshold of a radio signal level that is too strong.

The method for managing installation according to one embodiment of the invention can indeed be advantageously improved by considering a slight extension of the optimal positioning area of the new wireless coverage extension device compared with the theoretical optimal positioning area, by modifying the values of the low and high thresholds for the optimal radio signal level. Indeed, when the user is on the edge of the optimal positioning area, a slight parasitic oscillation of the RSSI could cause them to move to the positioning area that is too close or to the positioning area that is too far away, and the hysteresis mechanism described above could encourage them to move to return to the optimal positioning area, even though they are already there. This problem is solved by extending the optimal positioning area, by artificially increasing the high threshold of an optimal radio signal level and reducing the low threshold of an optimal radio signal level.

However, the amplitude of the extension can advantageously be greater at the boundary between the optimal positioning area and the positioning area that is too far away, than at the boundary between the optimal positioning area and the positioning area that is too near.

Indeed, at the boundary with the positioning area that is too far away, it is essential not to tell the user that they are too far away when in reality their position is still good, as this would limit the amplitude of the Wi-Fi coverage extension.

However, at the boundary between the optimal positioning area and the positioning area that is too near, it is not problematic to tell the user mistakenly that they are too near an access point when in reality the mobile terminal is in an optimal positioning area. Indeed, the only effect of this erroneous indication will be to encourage the user to move their coverage extension device a little further away from the access point in question, which will advantageously increase the resulting wireless coverage extension.

According to one embodiment, such a method for managing installation also comprises rendering a number of first wireless coverage extension devices through which a radio signal exchanged between the additional wireless coverage extension device and the home gateway would pass, if the additional wireless coverage extension device were installed at the current position of the mobile terminal.

Indeed, in a local communication network comprising several wireless coverage extension devices, the latter can be connected in cascade. However, for optimal performance of the Wi-Fi network, it is important to limit the number of Wi-Fi hops from each wireless radio coverage extension device to the home gateway as much as possible.

As a result, in addition to the indications of the position of the mobile terminal with respect to the various access points, the application, according to one embodiment of the invention, also renders in real time the number of Wi-Fi hops that would link the new wireless coverage extension device, located at the user's current position, to the home gateway. This rendering can be done by displaying a message on the screen of the mobile terminal, or by rendering an audio message, or yet by transmitting a certain number of beeps. The rendering may indicate the number of Wi-Fi extenders between the new wireless coverage extension device and the home gateway (for example, an intermediate Wi-Fi extender), or the number of Wi-Fi hops (two in this example, that is one hop from the new device to the intermediate Wi-Fi extender, and one hop from the intermediate Wi-Fi extender to the home gateway). When the number of intermediate Wi-Fi extenders is greater than or equal to one (i.e. the number of hops is greater than or equal to two), the application then tells the user, by displaying a text message or rendering an audio message, to look for another suitable position for the new wireless coverage extension device, nearer the home gateway.

According to one embodiment, such a method also comprises rendering a message recommending connecting the additional wireless coverage extension device to the local communication network using a wired communication technology, for example Ethernet.

Thus, at the start of the installation process, the application can tell the user that, if possible, connecting the Wi-Fi extender via Ethernet to the local communication network is preferable to a Wi-Fi connection.

The invention also relates to a computer program product comprising program code instructions for implementing the method as described previously, when it is executed by a processor.

The invention also relates to a computer-readable storage medium on which is saved a computer program comprising program code instructions for implementing the steps of the method for managing installation according to the invention as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the invention can be downloaded in particular on a network, for example the Internet network.

Alternatively, the storage medium can be an integrated circuit in which the program is embedded, the circuit being adapted to execute or to be used in the execution of the above-mentioned method for managing installation.

The invention further relates to device for managing the installation of an additional wireless coverage extension device in a local communication network comprising a home gateway and at least one first wireless coverage extension device. The home gateway and said at least one first wireless coverage extension device form access points to the local communication network. Such a device is capable of moving around within the local communication network.

It comprises at least one processor configured to:
determine an indication of position of the device with respect to said access points,
   it being possible for the indication of position to assume a value chosen from a group of values comprising an indication of position that is too far away, an indication of position that is too near, and an indication of position that is optimal;
render a suitable position for installing the additional wireless coverage extension device, the suitable position corresponding to a current position of the device when at least one of the indications of position assumes an indication of position value that is optimal and none of the indications of position assumes an indication of position value that is too near.

Preferably, such a device is integrated into a user mobile terminal, such as a smartphone or a tablet, for example.

The above-mentioned corresponding device for managing installation and computer program have at least the same advantages as those provided by the method for managing installation according to the present invention.

### PRESENTATION OF THE FIGURES

Other purposes, features and advantages of the invention will become more apparent upon reading the following description, hereby given to serve as an illustrative and non-restrictive example, in relation to the figures, among which:

FIG. 1 illustrates an example of an implementation environment of the invention according to a particular embodiment of the invention;

FIG. 2 illustrates in the form of a flowchart the various steps of the method for managing installation according to one embodiment of the invention;

FIG. 3 illustrates the hysteresis mechanism implemented according to one embodiment of the method of FIG. 2;

FIG. 4 illustrates the mechanism for extending the optimal positioning area implemented according to one embodiment of the method of FIG. 2;

FIG. 5 illustrates a practical example of implementation of the application for managing the installation of a new wireless coverage extension device, according to one embodiment, more particularly in a first position of a user;

FIG. 6 illustrates the practical example of FIG. 5, in a second position of the user;

FIG. 7 illustrates the practical example of FIG. 5, in a third position of the user;

FIG. 8 illustrates the practical example of FIG. 5, in a fourth position of the user;

FIG. 9 illustrates the final installation position of the new wireless coverage extension device in the practical embodiment of FIG. 5;

FIG. 10 illustrates the hardware structure of a device configured to implement the method for managing the installation of a wireless coverage extension device according to one embodiment of the invention.

### DETAILED DESCRIPTION OF THE EMBODIMENTS OF THE INVENTION

The method for managing the installation of a wireless coverage extension device described here enables a user to find an optimal position for a home device requiring a connection using a wireless technology to a local communication network, such as a Wi-Fi extender. Advantageously, it is not necessary to connect the Wi-Fi extender beforehand to identify this location.

This method is based on a dedicated application run by a mobile terminal of the user, such as a smartphone.

It allows the user to identify areas of their home where it is possible to install an additional wireless coverage extension device, in addition to one or more wireless coverage extension devices already installed, so that communication with the home gateway and wireless coverage of the home are optimised.

To do this, the user moves around in their home with their mobile terminal. Measurements of the radio signal levels exchanged between the mobile terminal and the various access points to the local communication network are performed in real time, rendering for the user indications of position that are too near, too far away or optimal with respect to the various access points. The user can adapt their position according to these indications. When they are in an optimal positioning area with respect to one of the access points, and they are not too near any of the access points, the current position of the mobile terminal corresponds to a suitable position for installing the additional wireless coverage extension device.

The radio signal levels can be measured by the mobile terminal or by the access points to the network. In the embodiment that will be described in more detail hereafter in relation to the figures, an example in which the measurements are performed by the access points to the local network is described. In other words, the access point (home gateway or Wi-Fi extender already installed) measures the reception level of the radio signal transmitted by the user's smartphone. This allows the software on the user's smartphone to be agnostic.

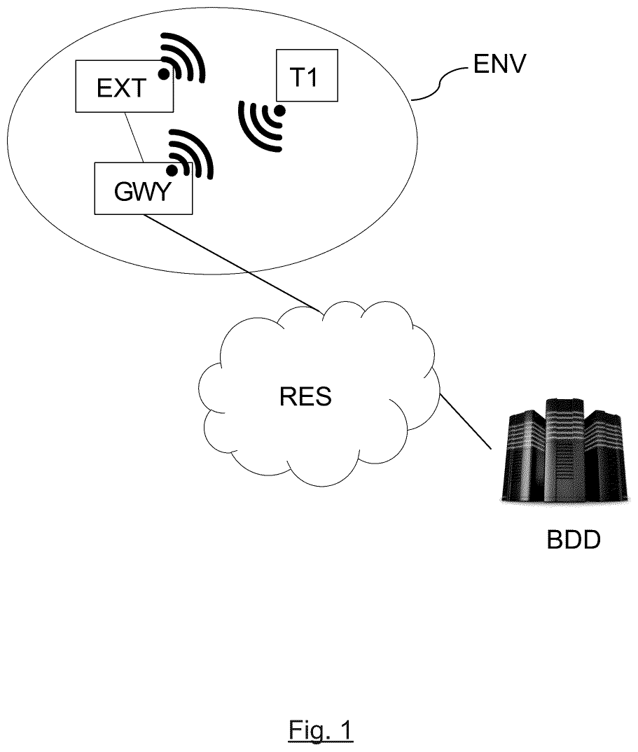

FIG. 1 illustrates an example of an implementation environment of the invention according to a particular embodiment of the invention. The implementation environment comprises a user's home environment ENV comprising a home gateway GWY connected to an IP (Internet Protocol) communication network, named RES in FIG. 1.

The home gateway GWY is configured on the one hand to exchange data with servers or terminals via the communication network RES, and on the other hand to set up a Wi-Fi wireless local network in the home environment ENV. Thus, home devices of the user placed in the home environment ENV can communicate to/from the communication network RES via the Wi-Fi local network of the home gateway GWY. The user's home environment ENV may comprise, for example, one or more areas that are not covered by the Wi-Fi local network of the home gateway GWY, because they are out of range of the radio signal, or where the radio signal level is too weak.

In these non-covered or poorly covered areas, when the user wants to use a home device requiring a connection to the Wi-Fi local network of the home gateway GWY, the Wi-Fi service is too weak or non-existent because the area is too far away from the home gateway GWY or obstacles impacting the Wi-Fi links are placed between the home device and the home gateway GWY.

It is known to use wireless coverage extension devices to resolve this disadvantage, for example a Wi-Fi extender noted EXT in FIG. 1. Such a Wi-Fi extender relays to home devices the signals exchanged with the home gateway in order to extend the latter's coverage area and thus reduce the extent of non-covered areas.

According to one embodiment of the invention, the method for managing the installation of an additional wireless coverage extension device allows, in a home environment in which the local communication network comprises at least two access points, namely the home gateway GWY and at least one first Wi-Fi extender EXT, to identify the area(s) in which to install an additional Wi-Fi extender. Such a method is implemented, for example, by a mobile terminal T1, for example a smartphone, on which a dedicated application has been downloaded and installed. The terminal T1 is configured to communicate with the home gateway GWY and with the Wi-Fi extender EXT, for example via the Wi-Fi local network of the home gateway GWY.

According to a particular embodiment of the invention, the implementation environment also comprises a database BDD configured to store Wi-Fi signal level thresholds used by the method for managing installation according to one embodiment of the invention. Such a database BDD is for example connected to the communication network RES in order to communicate with the terminal T1.

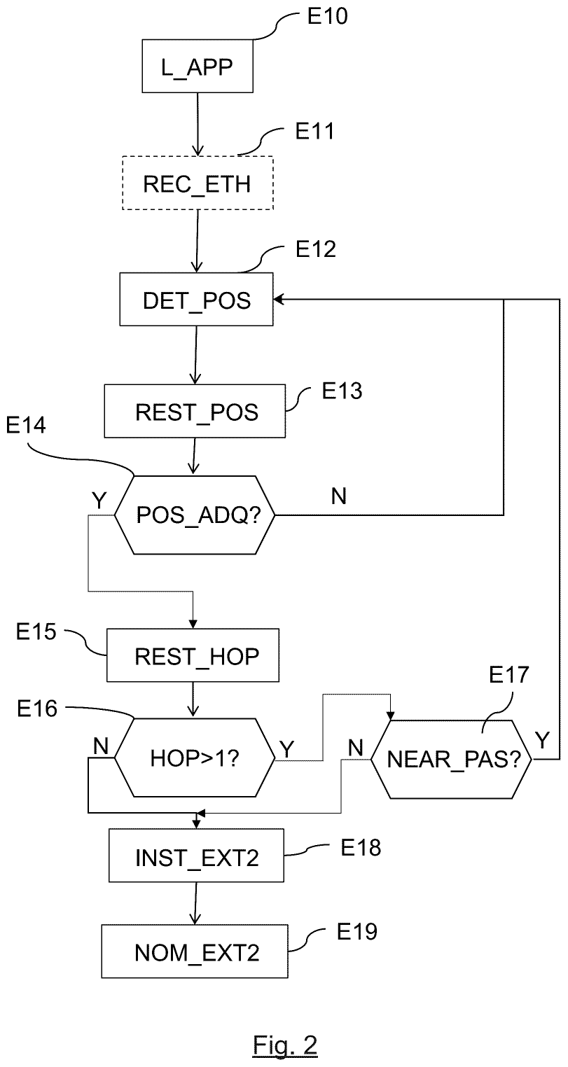

FIG. 2 illustrates in the form of a flowchart the various steps of the method for managing installation according to one embodiment of the invention.

During an L_APP step E10, the user launches the execution of the application for managing the installation of a Wi-Fi extender that they have previously installed on their terminal T1.

In an optional REC_ETH prior step E11, the terminal T1 renders for the user a message recommending a wired connection, for example an Ethernet connection, rather than a wireless connection, for example Wi-Fi, for the new Wi-Fi extender they want to install. This message may be a voice message sent by the terminal T1, or a text message displayed on the screen of the mobile terminal T1.

In a DET_POS step E12, the terminal T1 determines an item of information relating to its position with respect to each of the access points to the local network, namely, in the example shown of FIG. 1, the home gateway GWY and the first Wi-Fi extender EXT already installed.

In a preferred embodiment, the position of the terminal T1 with respect to each Wi-Fi access point is assessed in real time by the access points measuring the Wi-Fi signal levels transmitted by the terminal T1, that is the RSSI (Received Signal Strength Indicator). The RSSI values measured by each access point are, for example, centralised at the home gateway GWY by a master software agent, that transmits them to the installation management application running on the terminal T1.

Thus, in step E12, the terminal T1 obtains an item of information representative of a Wi-Fi signal level transmitted by the mobile terminal and received by each access point. Such an item of Wi-Fi signal information is received by the terminal T1 from the gateway GWY.

For example, the application run by the terminal T1 calls a Web API of the home gateway GWY to obtain the signal level RSSI received by each access point from the terminal T1, and the home gateway GWY transmits such a signal level to it. By comparing the RSSI values with thresholds whose values have been determined experimentally, it is possible to determine whether the terminal T1 is too near an access point, too far away from an access point, or at an optimal distance from an access point.

The threshold values used depend on the Wi-Fi band to which the smartphone T1 is connected at a given time, that is the 2.4 GHz or 5 GHz Wi-Fi band, for example.

For a mobile terminal T1 connected via Wi-Fi to the 2.4 GHz band, it can be considered that the boundary between a positioning area that is too far away and an optimal positioning area with respect to an access point is associated with an RSSI threshold value comprised between approximately-79 dBm and −86 dBm. Similarly, the boundary between a positioning area that is too near and an optimal positioning area with respect to an access point is associated with an RSSI threshold value comprised between approximately-57 dBm and −64 dBm.

To distinguish between the positioning areas that are “too near”, “optimal” and “too far away” with respect to each Wi-Fi access point, the application relies on two RSSI thresholds to determine the boundary respectively between the positioning areas that are “too near” and “optimal” on the one hand, and between the positioning areas that are “optimal” and “too far away” on the other hand.

However, the RSSI used for positioning assistance is, by nature, an item of information that is subject to constant variation, as it is influenced, for example, by the way the user holds their smartphone, or by the user's position with respect to their smartphone and to the Wi-Fi access points.

When the user is near the boundaries between positioning areas, these variations can generate oscillations of the indications of position determined by the application. Thus, even if the user is no longer moving, the application could, for example, consider sometimes that they are in the positioning area that is “too near” and sometimes that they are in the “optimal” positioning area, with a change every 2 to 3 seconds.

This could lead to confusing indications for the user, and would hinder the correct positioning of the new Wi-Fi extender.

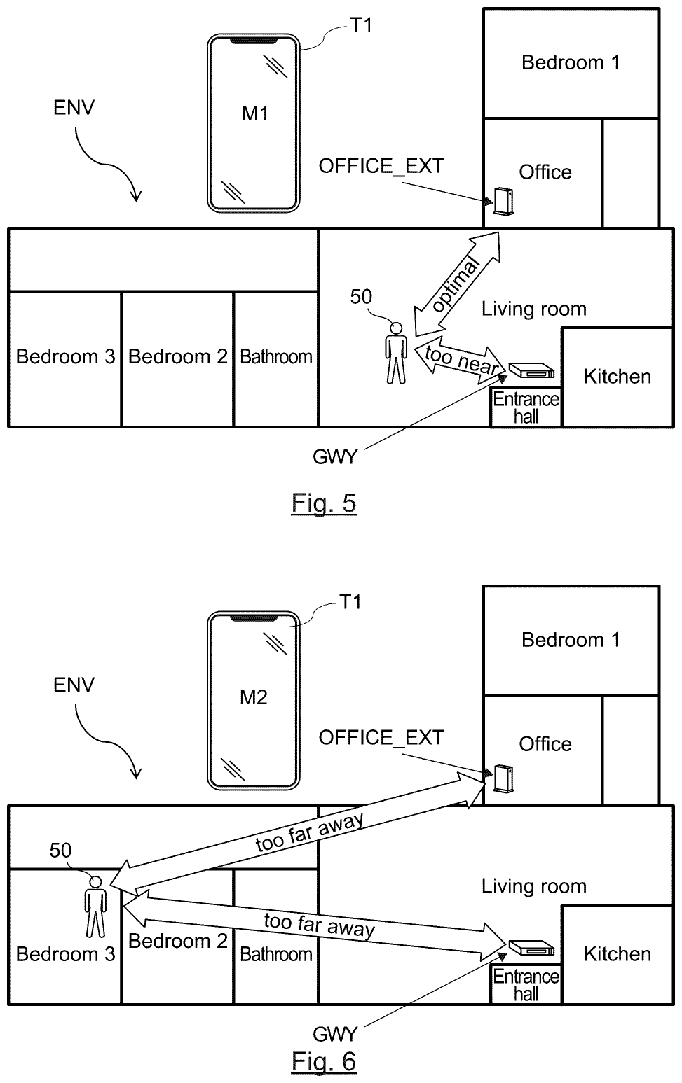

Indeed, the indications of position determined during the DET_POS step E12 are rendered for the user in real time during a REST_POS step E13, as will be seen in more detail hereafter in relation to FIGS. 5 to 9.

During this REST_POS step E13, the indications that the application can render for the user to guide them are, for example:
you are too near the home gateway GWY and/or the extender(s) EXT;
you are too far away from the home gateway GWY and the other extender(s) EXT;
you are in an optimal area for installing your new Wi-Fi extender.

Until the application informs them that they are in a suitable area for installing the new Wi-Fi extender, the user is invited to move around their home environment ENV.

To avoid the above-mentioned problems of oscillation of the indications of position values, one embodiment of the invention is based on the joint implementation of three mechanisms:
MEC1—use of the average of the latest RSSI values instead of the instantaneous RSSI value;
MEC2—modification of the thresholds according to the area in which the user is located (hysteresis mechanism);
MEC3—(limited) extension of the “optimal” positioning area to compensate for the impact of the RSSI residual oscillation that may remain even after averaging.

The first mechanism MEC1 consists in calculating the average of several successive RSSI measurements, and comparing this average with the various thresholds defining the boundaries between areas to determine the indication of position value of the terminal T1 with respect to an access point. For example, if the access point performs an RSSI measurement every 0.5 s, it calculates an average over four samples, that is over a time window of two seconds. It should be noted that it is important to limit the number of RSSI samples used for averaging, in order to avoid introducing too much inertia into the assessment of the position of the mobile terminal T1 with respect to the various access points.

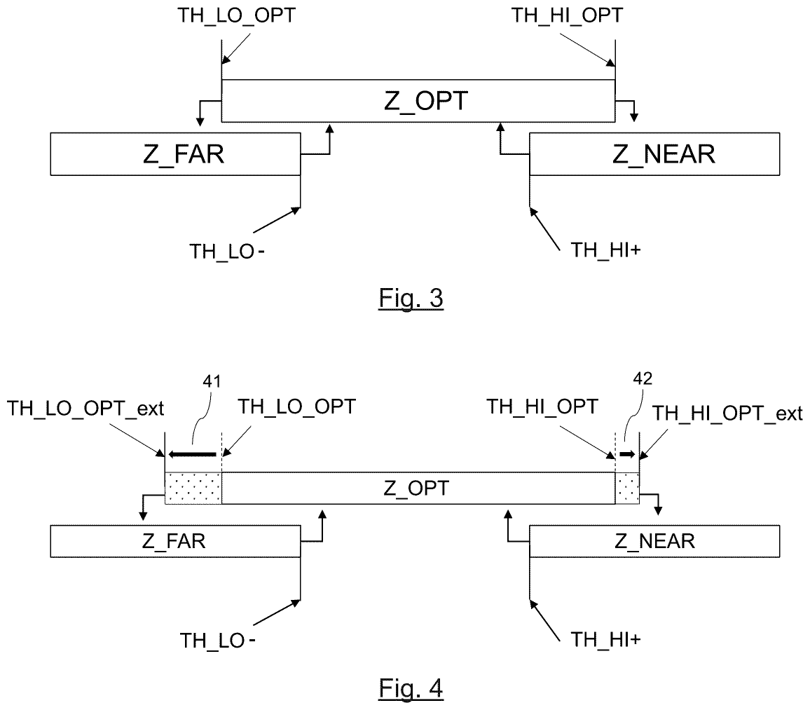

As a result, even after averaging, the RSSI may still oscillate. The hysteresis mechanism MEC2, shown in FIG. 3, is therefore introduced.

In this FIG. 3, three positioning areas of the terminal T1 with respect to an access point to the network are illustrated, for example the gateway GWY or the first Wi-Fi extender EXT.

The Z_OPT area corresponds to an optimal positioning area with respect to the access point; the Z_FAR area corresponds to a positioning area that is too far away with respect to the access point; finally, the Z_NEAR area corresponds to a positioning area that is too near with respect to the access point.

The hysteresis mechanism MEC2 consists in using two different RSSI thresholds at the boundary between two areas.

Thus, if the terminal is located in the optimal positioning area Z_OPT with respect to the access point, depending on the RSSI value measured, and possibly averaged, the RSSI value must fall below a low threshold of an optimal radio signal level TH_LO_OPT, for its indication of position with respect to the access point to assume the value “too far away”, and for the terminal T1 therefore to be located by the application in the Z_FAR area. Conversely, if the terminal is located in the positioning area that is too far away from the access point Z_FAR, depending on the RSSI value measured, and possibly averaged, the RSSI value must rise above a threshold of a radio signal level that is too weak TH_LO−, for its indication of position with respect to the access point to assume the indication of position value that is optimal, and for the terminal T1 therefore to be located by the application in the Z_OPT area. The low threshold of an optimal radio signal level TH_LO_OPT is strictly lower than the threshold of a radio signal level that is too weak TH_LO−, for example about 4 dBm lower.

This avoids undesirable oscillations of the indication of position values of the mobile terminal T1, due to fluctuations in the RSSI values measured, and possibly averaged, when the user is at the boundary between the Z_OPT and Z_FAR areas.

Similarly, when the installation management application determines that the terminal T1 is in the optimal positioning area Z_OPT with respect to an access point, it will only change the value of this indication of position that is “too near” if the RSSI value measured, or the average of the RSSI values measured over a given time window, rises above a high threshold of an optimal radio signal level TH_HI_OPT. Conversely, if the terminal T1 is considered to be too near the access point, and is therefore located by the application in the Z_NEAR area, the application will only determine that the terminal T1 passes into the optimal positioning area Z_OPT if the RSSI value measured, or the average of the RSSI values measured, falls below a threshold of a radio signal level that is too strong TH_HI+, which is strictly lower than a high threshold of an optimal radio signal level TH_HI_OPT, for example by approximately 4 dBm.

The low and high thresholds of an optimal radio signal level TH_LO_OPT and TH_HI_OPT are therefore the thresholds that, when crossed by the RSSI, trigger a change in the indication of position value of the terminal T1 with respect to the access point, when the user is considered by the installation management application to be in the optimal positioning area Z_OPT.

On the other hand, the thresholds of a radio signal level that is too strong TH_HI+, respectively too weak TH_LO−, are the RSSI thresholds used to trigger a change of positioning area when the application considers that the terminal T1 is located in a positioning area Z_NEAR that is too near the access point, respectively Z_FAR that is too far away.

To improve this operating mode further, and to avoid any slight parasitic oscillation of the RSSI when the user is on the edge of the optimal positioning area Z_OPT, in one advantageous embodiment, the optimal positioning area Z_OPT is extended slightly, with respect to the theoretical optimal positioning area, defined by the low and high thresholds of an optimal radio signal level TH_LO_OPT and TH_HI_OPT, according to the MEC3 mechanism.

This embodiment variant is illustrated in FIG. 4. Thus, the optimal positioning area Z_OPT considered by the application is slightly extended in both directions with respect to the theoretical optimal positioning area, by adding the two extension areas referenced 41 and 42. In other words, a new extended low threshold of an optimal radio signal level TH_LO_OPT_ext is introduced, which may be, for example, 3 dBm lower than the low threshold of an optimal radio signal level TH_LO_OPT. Similarly, a new extended high threshold of an optimal radio signal level TH_HI_OPT_ext is introduced, which may be 1 dBm higher than the high threshold of an optimal radio signal level TH_HI_OPT, for example.

This is because the amplitude of the extension may be greater at the boundary with the positioning area that is too far away Z_FAR than the one applied at the boundary with the positioning area that is too near Z_NEAR. Actually, at the boundary with the positioning area that is too far away Z_FAR, it is essential not to tell the user that they are too far away when in reality their position is still good, as this would limit the amplitude of the Wi-Fi coverage extension.

However, at the boundary with the positioning area that is too near Z_NEAR, it is not critical to tell the user that they are too near when in reality their position is in the optimal area Z_OPT, as this will simply encourage the user to move their Wi-Fi extender a little further away from the access point considered, which in turn will increase the amplitude of the Wi-Fi coverage extension.

The three mechanisms MEC1, MEC2 and MEC3 described above are implemented in real time for each of the access points GWY and EXT already installed.

According to a particular embodiment of the invention, the various thresholds used by the terminal T1 to implement the method described above are obtained by the terminal T1 from a database BDD (in FIG. 1). For example, in step E10 of launching the application for managing the installation of a wireless coverage extension device, the mobile terminal T1 can query the database BDD via the home gateway GWY and the communication network RES to obtain the values of the thresholds TH_LO_OPT, TH_HI_OPT, TH_LO, TH_HI+, TH_LO_OPT_ext and TH_HI_OPT_ext to be used.

According to another particular embodiment of the invention, the thresholds can be provided to the terminal T1 when downloading the application.

According to another particular embodiment of the invention, the threshold values are stored in the database BDD in association with at least one characteristic of the mobile terminal T1. According to this variant, when the mobile terminal T1 queries the database BDD, it provides an item of information indicative of this characteristic so that the database BDD sends to it the corresponding threshold values. Thus, the threshold values can be adapted according to the characteristics of the mobile terminal implementing the method. For example, such a characteristic of the mobile terminal may be a type of operating system of the terminal, a type of Wi-Fi connection, etc.

For example, the thresholds are defined according to the type of connection of the terminal T1. In other words, the thresholds are different if the terminal T1 is connected to the 2.4 GHz Wi-Fi or to the 5 GHz Wi-Fi. The result of the method is therefore not dependent on the characteristics of the terminal T1.

According to another variant, the threshold values are stored in the database BDD in association with a characteristic relating to the wireless coverage extension device to be installed, for example, the power of the Wi-Fi extender.

Returning to the description of FIG. 2, the three mechanisms described above are therefore implemented for the most accurate possible rendering of the indications of position of the terminal T1 with respect to each of the access points to the local network, in the REST_POS step E13.

During a POS_ADQ ? step E14, the application tests the indications of position of the terminal T1 with respect to the various access points GWY and EXT of the local network, to determine whether it is in a suitable position for installing the new Wi-Fi extender EXT2.

As soon as the terminal T1 is in an optimal positioning area Z_OPT with respect to an access point, for example the gateway GWY, and it is not, for any other access point EXT, in a positioning area that is too near Z_NEAR, the application considers that it is in a suitable position. If this is not the case, the user is invited to move around their home ENV, searching for a suitable position.

In the context of a local network comprising multiple Wi-Fi extenders, the latter can be connected in cascade. However, for optimal performance of the Wi-Fi network, it is important to limit as much as possible the number of Wi-Fi hops from each Wi-Fi extender to the gateway GWY.

As a result, in addition to the indications of position with respect to the other access points rendered in step E13, the application will also display in real time, during a REST_HOP step E15, the number of Wi-Fi hops that would link the Wi-Fi extender EXT2, placed at the current position of the terminal T1, to the gateway GWY. If this number is greater than one (step E16), the application then tells the user, during a NEAR_PAS step E17, to check if a position a little nearer the gateway GWY would be possible.

Depending on the new current position of the terminal T1, steps E12 to E16 are repeated. However, while a reduction in the number of Wi-Fi hops is advantageously sought, this reduction is not always feasible, depending on the context. The message displayed to the user in the NEAR_PAS step E17 is therefore only a non-blocking recommendation.

If no other position, with a smaller number of Wi-Fi hops, is identified during steps E12 to E16, there may be no choice but to install the new Wi-Fi extender EXT2 at the current position of the terminal T1, which is then considered to be a suitable installation position.

Thus, in the case where the new Wi-Fi extender EXT2 is in direct radio contact with the gateway (only one hop), or in the case where it is not possible to identify a position meeting the installation criteria with only one Wi-Fi hop, the current position of the terminal T1 can be considered to be a suitable installation position, and the user can, during an INST_EXT2 step E18, install the new Wi-Fi extender in the local communication network, preferably via Ethernet.

During a NOM_EXT2 step E19, the user is invited to give a name to the new Wi-Fi extender they have just installed. This name can advantageously be used in the messages displayed by the application to guide the user through the installation of a future additional wireless coverage extension device.

In relation to FIGS. 5 to 9, a practical example of implementation of the application for managing the installation of a new wireless coverage extension device that can guide a user so that they find a suitable position for their new Wi-Fi extender, in order to benefit from the best wireless coverage performance in their home network, is now presented.

As illustrated in FIG. 5, a home environment ENV, represented as the plan of a house, comprising a living room, three bedrooms, an office, a bathroom, an entrance hall and a kitchen, is considered. A home gateway GWY has been installed in the living room, near the entrance hall. A first Wi-Fi extender EXT, named OFFICE_EXT, is installed in the office. However, the user 50 wants to install a second Wi-Fi extender EXT2, as they are still facing Wi-Fi coverage issues in one wing of their home.

This user 50, equipped with the mobile terminal T1, is in the living room. They launch the installation management application described above in relation to FIGS. 2 to 4. At this position, the installation management application determines that they are too near the gateway GWY, but in an optimal positioning area Z_OPT with respect to the extender OFFICE_EXT (step E12).

The application therefore asks the user 50 to go to the area of the home ENV whose Wi-Fi coverage is poor. The application then displays a message M1 “Please move away from your gateway” on the screen of the terminal T1 (step E13).

It is assumed that the user 50 goes there, but without looking at the screen of their smartphone T1, and therefore moves too far away. As illustrated in FIG. 6, they go to Bedroom 3. At this position, the installation management application determines that they are too far away from each of the two access points GWY and OFFICE_EXT (step E12). A message M2 “Please move nearer your gateway or one of the extenders” displays on the screen of the smartphone T1 (step E13).

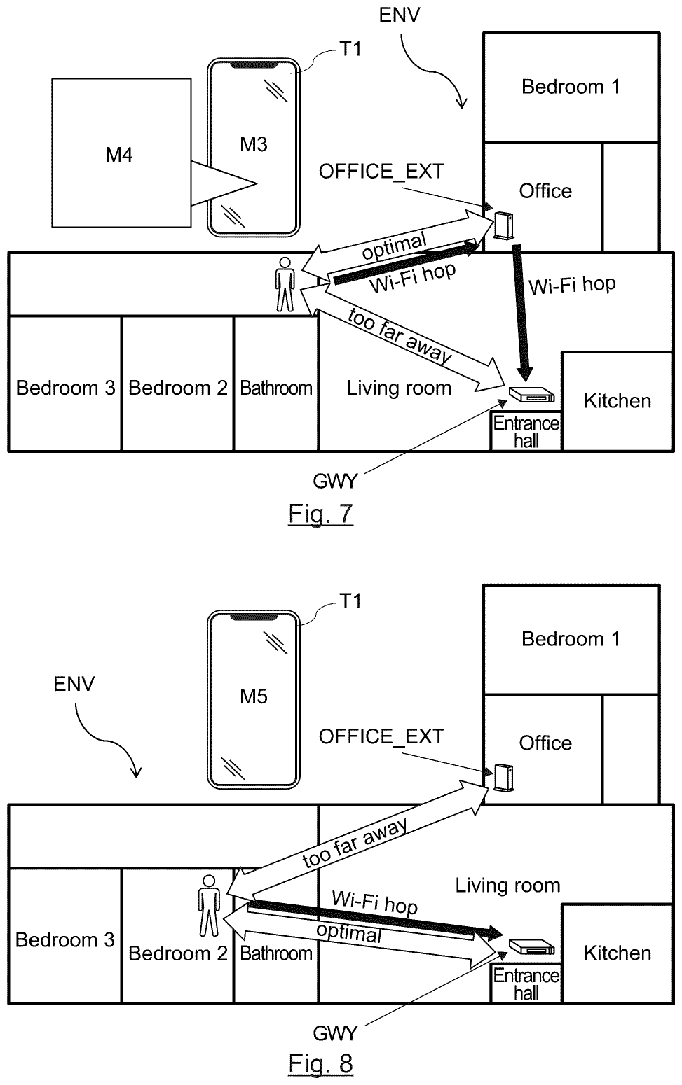

Following the instructions from the application, the user 50 moves nearer the two existing access points GWY and OFFICE_EXT, and arrives in the position illustrated in FIG. 7, that is in the corridor, close to the bathroom. According to the test performed in step E14 of FIG. 2, the application determines that this position is a suitable position for positioning the new Wi-Fi extender EXT2, because the terminal T1 is at an optimal distance from the first extender OFFICE_EXT, and is not too near the gateway GWY. The application then displays a message M3 on the screen of the terminal T1: “You are in an optimal area for installing your new extender”. However, according to the test performed in step E16 of FIG. 2, the application determines that at this position, two Wi-Fi hops would separate the new extender EXT2 from the home gateway GWY. A warning M4 is therefore displayed on the screen of the terminal T1: “2 Wi-Fi hops would link your extender to the gateway. In order to optimise the performance of your network, please check if a location nearer the gateway can be found” (step E17).

As illustrated in FIG. 8, the user 50 follows the instructions from the application, and moves nearer the gateway GWY by standing in the Bedroom 2. At this place, the new Wi-Fi extender EXT2 would connect directly to the gateway GWY, so there would only be one Wi-Fi hop left between them. The application displays a message M5 on the screen of the terminal T1: “You are in an optimal area for installing your new extender”.

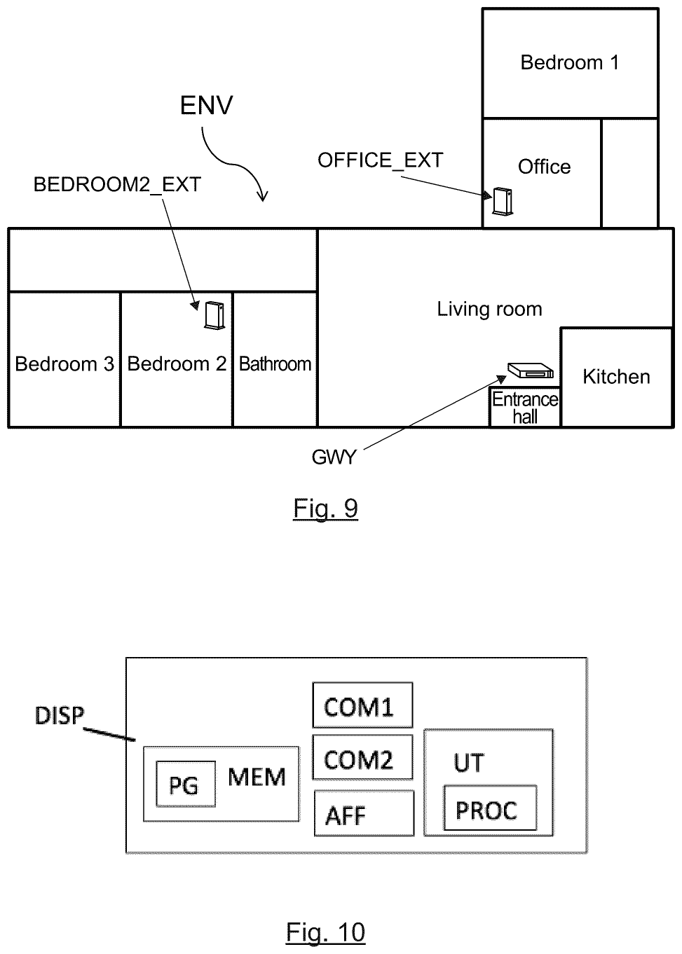

The user 50 therefore decides to connect their new Wi-Fi extender EXT2 in the room “Bedroom 2”, as illustrated in FIG. 9 (step E18). They give it the name BEDROOM2_EXT, for example by entering it on the screen of the smartphone T1 (step E19), or by voice recording.

Thanks to this optimal position of their Wi-Fi extender with respect to the existing access points, and to a direct connection (only one Wi-Fi hop) of the new Wi-Fi extender to the gateway GWY, the user 50 will benefit from the best possible Wi-Fi performance in their home ENV. In relation to FIG. 10, the hardware structure of a device DSP configured to implement the method for managing the installation of a wireless coverage extension device according to one embodiment of the invention is now presented.

According to a particular embodiment of the invention, the device DISP has the standard architecture of a mobile phone such as a smartphone, and notably comprises a memory MEM, a processing unit UT, equipped for example with a processor PROC, and driven by the computer program PG stored in the memory MEM. The computer program PG comprises instructions for implementing the steps of the method for managing the installation of a wireless coverage extension device as described previously, when the program is executed by the processor PROC.

At initialisation, the code instructions of the computer program PG are for example loaded into a memory before being executed by the processor PROC. The processor PROC of the processing unit UT notably implements the steps of the method for managing the installation of a wireless coverage extension device according to any one of the particular embodiments described in relation to FIGS. 2 to 9, according to the instructions of the computer program PG.

The device DISP comprises a communication module COM1 configured to establish communications with an IP network and/or a home gateway GWY using a Wi-Fi technology.

According to a particular embodiment of the invention, the device DISP comprises a communication module COM2 configured to establish communications via a 3G/4G or 5G mobile communication network.

The device DISP also comprises a display module AFF for displaying installation assistance messages on a screen. As a variant, the display module AFF allows the audio rendering of guidance audio messages intended for the user.

The term “module” can correspond to a software component as well as to a hardware component or a set of hardware and software components, a software component itself corresponding to one or more computer programs or sub-programs, or more generally, to any element of a program capable of implementing a function or set of functions.

FIG. 10 only shows a particular one of several possible ways of realising the device DISP, so that it executes the steps of the method detailed above, in relation to FIGS. 2 to 4 (in any one of the various embodiments, or in a combination of these embodiments). Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device DISP is realised with a reprogrammable computing machine, the corresponding program (i.e. the sequence of instructions) can be stored in a removable (such as, for example, a floppy disk, CD-ROM or DVD-ROM) or non-removable storage medium, this storage medium being partially or totally readable by a computer or a processor.

The invention has just been described in the case of a Wi-Fi technology and a Wi-Fi local network of a home gateway. However, the principle of the invention described above is not limited solely to the particular embodiments described above. According to other particular embodiments of the invention, the invention also applies to other types of wireless technology, for example Bluetooth, and to other types of devices.

1. A method, implemented in a local communication network comprising a home gateway and at least one first wireless coverage extension device, for managing the installation of an additional wireless coverage extension device, said home gateway and said at least one first wireless coverage extension device forming access points to said local network, said method being implemented by a mobile terminal capable of moving around within said local communication network, and comprising:
determining an indication of position of said mobile terminal with respect to said access points to said local network, it being possible for said indication of position to assume a value chosen from a group of values comprising an indication of position that is too far away, an indication of position that is too near, and an indication of position that is optimal; and
rendering a suitable position for installing said additional wireless coverage extension device, said suitable position corresponding to a current position of said mobile terminal in response to at least one of said indications of position assuming an indication of position value that is optimal and none of said indications of position assuming an indication of position value that is too near.

2. The method according to claim 1, wherein, as long as said suitable installation position has not been rendered, the method implements a rendering of said indications of position assuming an indication of position value that is too far away and/or an indication of position value that is too near.

3. The method according to claim 1, wherein said determination of an indication of position of said mobile terminal with respect to one of said access points comprises at least one measurement of an instantaneous level of radio signal exchanged between said mobile terminal and said access point.

4. The method according to claim 3, wherein said mobile terminal communicates with said access points using a Wi-Fi wireless communication technology, said measurement of an instantaneous level of radio signal comprises a measurement, by said access point, of the received signal strength indication of a Wi-Fi signal transmitted by said mobile terminal.

5. The method according to claim 4, wherein said determination of an indication of position of said mobile terminal with respect to one of said access points also comprises a calculation of an average value of measurements, by said access point, of the received signal strength indication of the Wi-Fi signal transmitted by said mobile terminal, over a time window of a defined duration.

6. The method according to claim 3, wherein a change in said indication of position value occurs when said radio signal level measured crosses a defined radio signal level threshold.

7. The method according to claim 6, wherein said indication of position changes from an indication of position value that is optimal to an indication of position value that is too far away, respectively too near, when said measured radio signal level falls below a low threshold of an optimal radio signal level, respectively rises above a high threshold of an optimal radio signal level,
and wherein said indication of position changes from an indication of position value that is too far away, respectively too near, to an indication of position value that is optimal when said measured radio signal level rises above a threshold of a radio signal level that is too weak, respectively falls below a threshold of a radio signal level that is too strong,
and wherein said low threshold of an optimal radio signal level is lower than said threshold of a radio signal level that is too weak and said high threshold of an optimal radio signal level is higher than said threshold of a radio signal level that is too strong.

8. The method according to claim 7, wherein a difference between said threshold of a radio signal level that is too weak and said low threshold of an optimal radio signal level is greater than a difference between said high threshold of an optimal radio signal level and said threshold of a radio signal level that is too strong.

9. The method according to claim 1, wherein the method also comprises rendering a number of first wireless coverage extension devices through which a radio signal exchanged between said additional wireless coverage extension device and said home gateway would pass, if said additional wireless coverage extension device were installed at said current position of said mobile terminal.

10. The method according to claim 1, wherein the method also comprises rendering a message recommending connecting said additional wireless coverage extension device to said local communication network using a wired communication technology.

11. A non-transitory computer readable medium comprising program code instructions stored thereon for implementing a method for managing installation of an additional wireless coverage extension device in a local communication network comprising a home gateway and at least one first wireless coverage extension device, when it is the instructions are executed by a processor of a mobile terminal, said home gateway and said at least one first wireless coverage extension device forming access points to said local network, said mobile terminal capable of moving around within said local communication network, and said method comprising:
determining an indication of position of said mobile terminal with respect to said access points to said local network, it being possible for said indication of position to assume a value chosen from a group of values comprising an indication of position that is too far away, an indication of position that is too near, and an indication of position that is optimal; and
rendering a suitable position for installing said additional wireless coverage extension device, said suitable position corresponding to a current position of said mobile terminal in response to at least one of said indications of position assuming an indication of position value that is optimal and none of said indications of position assuming an indication of position value that is too near.

12. A device for managing installation of an additional wireless coverage extension device in a local communication network comprising a home gateway and at least one first wireless coverage extension device, said home gateway and said at least one first wireless coverage extension device, forming access points to said local network, said device being capable of moving around within said local communication network and comprising:
at least one processor configured to:
determine an indication of position of said device with respect to said access points to said local network, it being possible for said indication of position to assume a value chosen from a group of values comprising an indication of position that is too far away, an indication of position that is too near, and an indication of position that is optimal; and
render a suitable position for installing said additional wireless coverage extension device, said suitable position corresponding to a current position of said device in response to at least one of said indications of position assuming an indication of position value that is optimal and none of said indications of position assuming an indication of position value that is too near.
